(19) United States
(12) Patent Application Publication
(10) Pub. No.: US 2004/0020346 A1
(43) Pub. Date: Feb. 5, 2004

(54) Guitar tuner

(76) Inventor: Masaji Kondo, Chiba-shi (JP)

Correspondence Address: ADAMS & WILKS, 31st Floor, 50 Broadway, New York, NY, 10004, US

(21) Appl. No.: 10/410,225

(22) Filed: Apr. 9, 2003

(30) Foreign Application Priority Data
Apr. 18, 2002 (JP) 2002-116567

(51) Int. Cl. G10G 7/02

(52) U.S. Cl. 84/454

(57) ABSTRACT

Provided is a guitar tuner that is capable of tuning each string of a guitar with a capotasto being attached thereto to a specified pitch. The guitar tuner includes attachment position setting means for, when the capotasto is attached to the guitar, setting an attachment position of the capotasto to the tuner, and a pitch of each string can be automatically set to a pitch that is specified in the attachment position of the capo.

### BACKGROUND OF THE INVENTION

1. Field of the Invention

The present invention relates to a pitch setting of a tuner for tuning a guitar.

2. Description of the Related Art

Up to now, there are known guitar tuners that pick up a sound outputted from a musical instrument as a signal by various input means and determine a pitch name and an octave based on the waveform of the obtained signal to display the result. However, the conventional tuners are used only for tuning a pitch of an open string.

When playing a guitar, in order to change a key, a capotasto for pressing all strings down on the same fret at the same time maybe used. The use of the capotasto leads to the following problem. That is, even if each open string has been tuned to a specified pitch without attaching the capo, each corresponding string at the time when the capotasto is attached has different tension and a pitch deviated from the specified pitch. As a result, it is necessary to perform tuning again with the capotasto being attached. At that time, the pitch of each string deviates from that of the corresponding open string depending on a position in which the capotasto is to be attached, so that it is impossible to use the guitar tuner.

### SUMMARY OF THE INVENTION

In order to solve the above-mentioned conventional problem, an object of the present invention is to provide attachment position setting means for, when a capotasto is attached to a guitar, setting an attachment position of the capotasto to a tuner and means for displaying the attachment position, and to make it possible to automatically set a pitch of each string to a pitch that is specified in the attachment position of the capo.

In order to solve the above problem, according to the present invention, there is provided a guitar tuner including attachment position setting means for, when a capotasto is attached to a guitar, setting an attachment position of the capotasto to the tuner and means for displaying the attachment position, in which a pitch of each string can be automatically set to a pitch that is specified in the attachment position of the capo.

### BRIEF DESCRIPTION OF THE DRAWINGS

In the accompanying drawings:

FIG. 1 is a circuit block diagram of a guitar tuner of the present invention;

FIG. 2 is a pitch table showing a pitch of each string of a guitar at each fret;

FIG. 3 shows display means of a guitar tuner according to an embodiment of the present invention; and

FIG. 4 is a schematic perspective view showing the guitar tuner according to the embodiment of the present invention when the guitar tuner is integrated with a capo, and a vibration sensor and a microphone are selectively used as input means.

### DETAILED DESCRIPTION OF THE PREFERRED EMBODIMENT

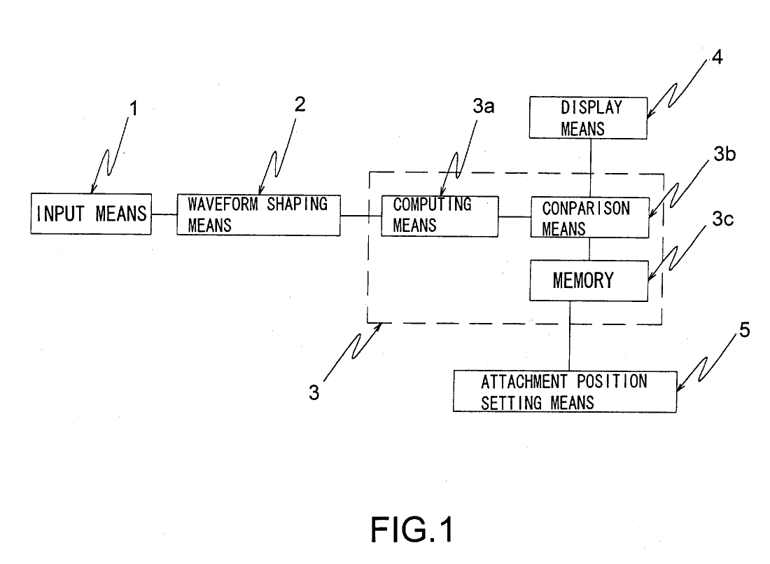

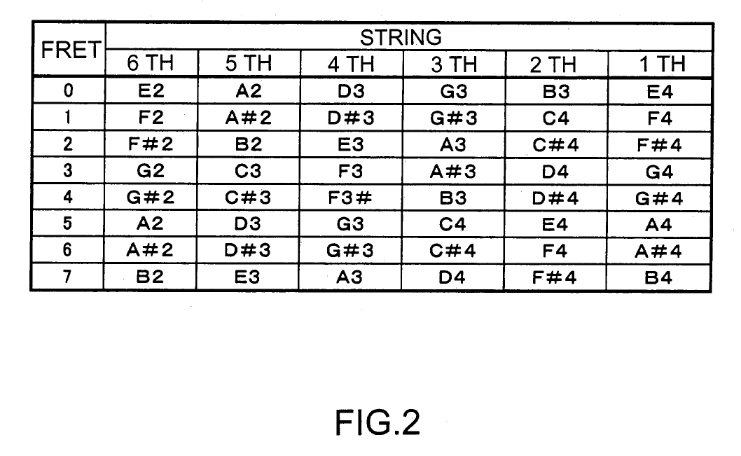

A description will be made of an embodiment of a guitar tuner according to the present invention with reference to the attached drawings. FIG. 1 is a circuit block diagram showing a structure of the guitar tuner according to the embodiment of the present invention. FIG. 2 is a pitch table showing a pitch of each string of a guitar at each fret. Hereinafter, the description will be made based on FIGS. 1 and 2. First, in a state where a capotasto is attached to the guitar, a sound outputted from the guitar is inputted to a waveform shaping circuit 2 through input means 1. Examples of the input means 1 include a jack, a microphone, and a sensor. The input means 1 serves to input the sound outputted from the guitar to the tuner as a signal. The waveform shaping circuit 2 converts a signal of the inputted sound into a pulse shape signal, which is inputted to computing means 3a as an output signal from the waveform shaping circuit 2. The waveform shaping circuit 2 is composed of an operational amplifier, a transistor, and the like.

The computing means 3a computes a frequency of the sound outputted from the guitar by measuring a pulse number per unit time of the signal inputted from the waveform shaping circuit 2. A frequency corresponding to a pitch name of each string shown in FIG. 2 is stored in a memory 3c for each fret. Comparison means 3b is used to compare a value computed by the computing means 3a with data stored in the memory 3c and corresponding to a fret position set by attachment position setting means 5. Based on the compared result, display means 4 performs display.

Further, a push switch is used as the attachment position setting means 5. Every operation of the switch causes the data stored in the memory 3c to be switched for the subsequent data, and causes the fret position thus selected to be displayed in the display means 4.

Alternatively, in the case where a rotary switch is used as the attachment position setting means 5, data stored in the memory 3c and corresponding to each position of the rotary switch is switched. At the same time, each position of the rotary switch can also serve to display the fret position.

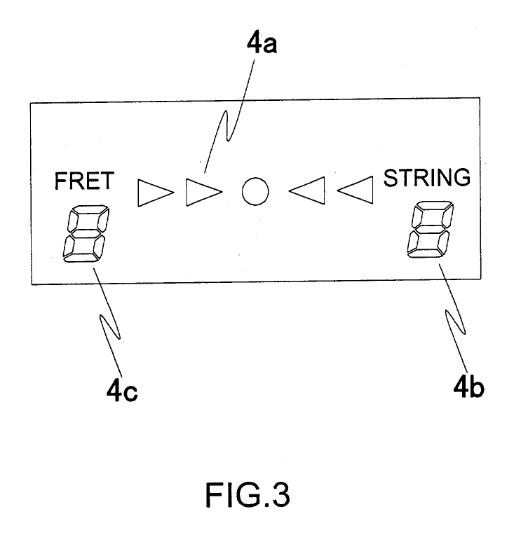

FIG. 3 shows the display means 4 of the guitar tuner according to the embodiment of the present invention. In this embodiment, a string name corresponding to the sound inputted from the guitar is displayed in a string name display portion 4b, and the deviation with respect to a specified frequency is displayed in a deviation display portion 4a. In addition, the display means 4 also includes a fret position display portion 4c for displaying the fret position set by the attachment position setting means 5. The display means 4 may be set as a display panel and composed of an LED device, a liquid crystal display device, and the like. Generally, a microcomputer 3 is used as the computing means 3a, the comparison means 3b, and the memory 3c.

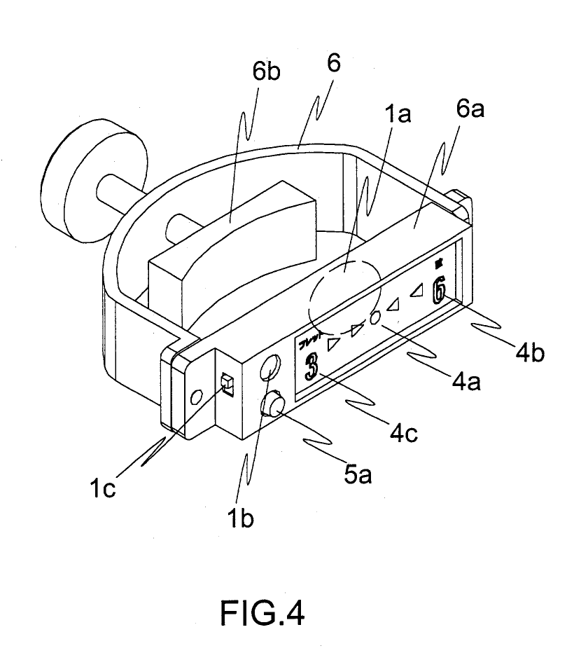

FIG. 4 is a schematic perspective view showing the guitar tuner according to the embodiment of the present invention when the guitar tuner is integrated with the capo, and a vibration sensor and a microphone are selectively used as input means 1. The capotasto 6 is composed of a tuner 6a that is integrated with a member for pressing each string of the guitar down on the fret, and a member 6b for attaching and fixing the tuner 6a to the guitar. The tuner 6a has the following components built thereinto: a vibration sensor 1a, a microphone 1b, and an input means selecting switch 1c, which serve to input the sound of the guitar; the waveform shaping circuit 2; the microcomputer 3; the display means 4; and an attachment position setting switch 5a.

When the capotasto 6 is attached to the guitar, the fret to which the guitar is attached is selected by means of the attachment position setting switch 5a, and the vibration sensor la is selected as the input means 1 by means of the input means selecting switch Ic to use the vibration of the string of the guitar as an input. When the capotasto 6 is not attached to the guitar, the attachment position setting switch 5a is operated to set the attachment position to “0”.

In that state, the vibration of the string of the guitar cannot be used as the input. Instead, the input means selecting switch 1c is used to select the microphone 1b as the input means 1, so that the sound of the guitar is used as the input. The description has been made by uniquely using the input means selecting switch 1c for selection of the input means 1. However, based on the value set by the attachment position setting switch 5a, the input means 1 can be automatically selected by a program of the microcomputer 3.

As described above, the guitar tuner includes attachment position setting means for, when the capotasto is attached to the guitar, setting the attachment position of the capotasto to the tuner, and a pitch of each string can be automatically set to a pitch that is specified in the attachment position of the capo. As a result, each string of the guitar with the capotasto being attached thereto can be tuned to the specified pitch.

What is claimed is:

1. A guitar tuner for tuning each string of a guitar to a specified pitch, comprising:
input means for inputting a sound of the guitar;
a waveform shaping circuit for converting a waveform of the inputted sound into a pulse shape;
computing means for computing a frequency of a signal from the waveform shaping circuit;
a memory in which a specified frequency of each string is stored;
comparison means for comparing a computed result from the computing means with the specified frequency stored in the memory;
display means for displaying a result from the comparison means; and
attachment position setting means for, when a capotasto is attached to a guitar, setting an attachment position of the capotasto to the guitar tuner; and
means for displaying the attachment position,
wherein a pitch of each string can be automatically set to a pitch that is specified in the attachment position of the capo.

2. A guitar tuner according to claim 1, wherein the guitar tuner is integrated with the capo.

3. A guitar tuner according to claim 2, wherein a vibration sensor and a microphone are selectively used as the input means for inputting the sound of the guitar.
